(19) United States
(12) Patent Application Publication
(10) Pub. No.: US 2007/0168737 A1
(43) Pub. Date: Jul. 19, 2007

(54) DEBUGGING DEVICE USING AN LPC INTERFACE CAPABLE OF RECOVERING FUNCTIONS OF BIOS, AND DEBUGGING METHOD THEREFOR

(76) Inventors: Wei-Ming Lee, Taipei City (TW); Dick Liu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,312

(22) Filed: Mar. 16, 2006

(30) Foreign Application Priority Data
Dec. 9, 2005 (TW) 94143541

(51) Int. Cl. G06F 11/00

(52) U.S. Cl. 714/36

(57) ABSTRACT

The present invention discloses a debugging device using an LPC interface and capable of recovering the BIOS functions and a debugging method therefor. The debugging device comprises a firmware hub, an LPC interface, a decoder, and a display unit. The LPC interface electrically connects to the decoder, the firmware hub, and a computer system. The decoder receives a POST code of the computer system to monitor a startup state of the computer system through the LPC interface, and then decodes and provides the decoded POST code to the display unit for showing every startup step of the computer system. When the original BIOS of the computer system is damaged, the firmware hub provides a backup BIOS for the computer system to start up, and recovers the original damaged BIOS. The present invention improves the stability of the computer system, and saves the cost and time of recovering the BIOS.

### CROSS-REFERENCE TO RELATED APPLICATION

This application claims the priority benefit of Taiwan application serial no. 94143541, filed on Dec. 9, 2005. All disclosure of the Taiwan application is incorporated herein by reference.

### BACKGROUND OF THE INVENTION

1. Field of the Invention

The present invention relates to a debugging device and a debugging method thereof, and more particularly, to a debugging device using an LPC interface capable of recovering functions of BIOS and a debugging method therefor.

2. Description of the Related Art

The conventional debugging card receives a POST (power on self test) code to display the debugging message through the PCI (peripheral component interconnection) bus interface or the MINI PCI (mini peripheral component interconnection) interface. Wherein, the POST code is the result of the power test on every component of the computer system when the computer system is booted up. For example, the POST code represents messages such as “the hard drive has failed physically” or “the memory test failed”. The conventional debugging card receives the POST code that is coded in Arabic numerals or alphabetical characters for providing the system power-on test result of the computer system to the user.

It is the trend that the structure of the computer system is designed to be faster and smaller. Especially, a new specification is applied in the NAPA (network application performance analyzer) platform on the notebook computer. The conventional MINI PCI interface is replaced with the new MINI CARD interface on the notebook computer. In addition, the POST code is transmitted to the LPC bus rather than transmitted to the original PCI bus, wherein the LPC bus is electrically coupled to the MINI CARD. Accordingly, the conventional debugging card using the PCI interface or the MINI PCI interface cannot be used in the new interface.

Moreover, if the original BIOS (basic input/output system) of the computer system is damaged by virus attacks or failure in updating the BIOS version, the computer system fails to start up. In the conventional technique, the damaged BIOS can be recovered by using a special equipment to reprogram the BIOS without needing to take out the motherboard. However, in the NAPA platform with higher speed and smaller space, the BIOS is usually programmed in an SPI FLASH (serial peripheral interface flash) component that has a smaller size. In order to adapt with the SPI FLASH component with a smaller size and to reduce the impact due to the variance of the socket quality, the SPI FLASH component is directly welded on the motherboard. In other words, once the BIOS is damaged, the whole set of SPI FLASH component must be taken out before a new component is replaced, which significantly increases the repairing cost and time.

### SUMMARY OF THE INVENTION

Therefore, it is an object of the present invention to provide a debugging device using an LPC interface and capable of recovering the BIOS functions. The debugging device saves cost and time spent in recovering the BIOS and replacing the BIOS component through the equipment. In addition, the debugging device extracts the POST code to monitor the startup state of the computer system through the LPC interface. Accordingly, the compatibility of the debugging device is improved and the component space is decreased.

It is another object of the present invention to provide a debugging device using an LPC interface and capable of recovering the BIOS functions. The debugging device can monitor the startup state of the computer system in real time, and save the cost spent in reprogramming the BIOS and replacing the BIOS component through the special equipment.

It is yet another object of the present invention to provide a debugging method for recovering the BIOS functions by using an LPC interface. The debugging method can recover the BIOS with a minimum cost and time, and also monitor the startup state of the computer system in real time through the LPC interface with high compatibility.

In order to achieve the objects mentioned above and others, the present invention provides a debugging device using an LPC interface and capable of recovering the BIOS functions. The debugging device comprises a firmware hub, a decoder, an LPC interface, and a display unit. Wherein, a backup copy of BIOS is stored in the firmware hub. When the original BIOS of the computer system is damaged, the firmware hub provides the backup BIOS for the computer system to start up and recover the original BIOS. The decoder receives a POST code of the computer system through the LPC interface, and then decodes and provides the decoded POST code to the display unit. The display unit displays the startup state of the computer system according to the decoded signal. Here, the LPC interface is electrically connected to the firmware hub, the decoder, and the computer system for transmitting the control signal of the firmware hub and the POST code of the computer system.

In accordance with a preferred embodiment of the present invention, the debugging device using the LPC interface and capable of recovering the BIOS functions mentioned above can be disposed in an object complying with a mini card industry specification.

From an aspect of the present invention, the present invention provides a debugging device using an LPC interface and capable of recovering the BIOS functions. The debugging device comprises a firmware hub and the LPC interface. When the original BIOS of the computer system is damaged and failed to startup, the backup copy of BIOS stored in the firmware hub can be provided for the computer system to start up, and the original BIOS of the computer system can be recovered by the backup BIOS. Here, the LPC interface is electrically connected to the firmware hub and the computer system and is used as a communication control interface between the firmware hub and the computer system.

In accordance with a preferred embodiment of the present invention, the debugging device using the LPC interface and capable of recovering the BIOS functions mentioned above can be disposed in an object complying with a mini card industry specification.

From another aspect of the present invention, the present invention provides a debugging method for recovering the BIOS functions by using an LPC interface. The debugging method comprises the following steps. First, the backup BIOS is stored. Then, when the original BIOS of the computer system is damaged and failed to startup, the backup BIOS is provided to the computer system through the LPC interface, such that the computer system is successfully started up. Then, the damaged original BIOS is recovered by using the backup BIOS.

In accordance with a preferred embodiment of the present invention, the debugging method for recovering the BIOS functions by using the LPC interface mentioned above further comprises the steps of receiving a POST code; and decoding the POST code to display the startup state of the computer system.

In the present invention, a structure of using the LPC interface and the firmware hub to recover the BIOS and obtaining the POST code is applied. Accordingly, the firmware hub can recover the damaged BIOS with a minimum cost and time in real time, and the POST code is obtained through the LPC interface that has a high compatibility and smaller space to recognize the startup state of the computer system.

### BRIEF DESCRIPTION OF THE DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a circuit diagram of a debugging device using an LPC interface and capable of recovering the BIOS functions according to an embodiment of the present invention.

FIG. 2 is a circuit diagram of a debugging device using an LPC interface and capable of recovering the BIOS functions according to another embodiment of the present invention.

FIG. 3 is a flow chart illustrating a debugging method for recovering the BIOS functions by using an LPC interface according to an embodiment of the present invention.

### DESCRIPTION OF THE PREFERRED EMBODIMENTS

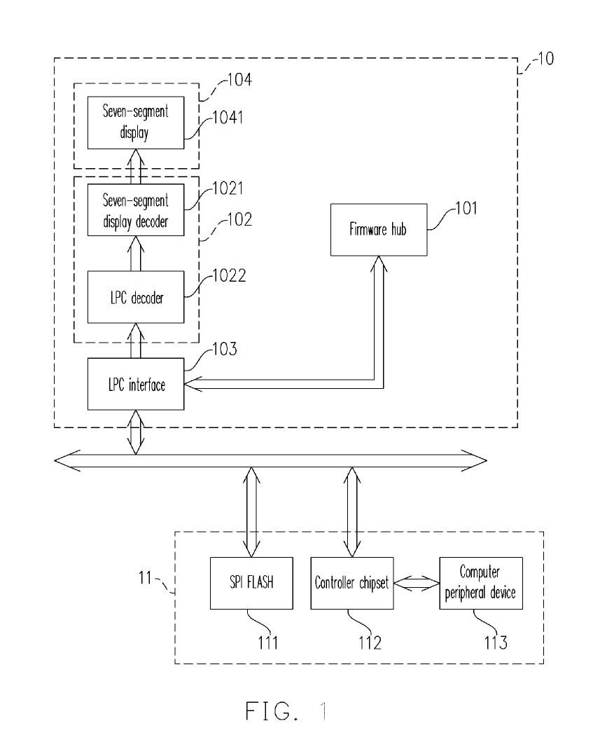

FIG. 1 is a circuit diagram of a debugging device using an LPC (low pin count) interface and capable of recovering the BIOS (basic input/output system) functions according to an embodiment of the present invention. The debugging device 10 comprises a firmware hub 101, a decoder 102, an LPC (low pin count) interface 103, and a display unit 104. The debugging device 10 uses the display unit 104 to display the startup error state of a computer system 11 and recovers the error BIOS code in the SPI (serial peripheral interface) FLASH that fails to startup.

The computer system 11 comprises the SPI FLASH 111, a controller chipset 112, and a computer peripheral device 113. The original BIOS stored in the SPI FLASH 111 is transmitted to the controller chipset 112 through the LPC bus, such that the computer system can successfully power up. When the computer system is starting up, the controller chipset 112 performs a power test on the computer peripheral device 113 and sends out a POST (power on self test) code to display the progress of the power test. Meanwhile, if the computer peripheral device 113 is malfunctioned and failed to power on, the POST code stops at a certain message because a component fails to operate in the computer peripheral device 113. By determining the POST code, it is possible to recognize the progress of the test on the computer peripheral device 113.

The decoder 102 electrically connected to the LPC interface 103 receives the POST code of the computer system 11 through the LPC interface 103, and then decodes and provides the decoded POST code to the display unit 104. The display unit 104 receives the decoded signal from the decoder 102 and displays the power-on progress. The display unit 104 of the present embodiment is embodied by a seven-segment display unit 1041, and the decoder 102 includes a seven-segment display decoder 1021 and an LPC decoder 1022. The LPC decoder 1022 receives the POST code of the computer system 11 from the LPC interface 103, and then decodes and provides the decoded signal to the seven-segment display decoder 1021. The seven-segment display decoder 1021 converts the decoded signal provided by the LPC decoder 1022 to a display signal of the seven-segment display unit 1041. The POST code is decoded by the seven-segment display decoder 1041 to respectively drive the LED (Light Emitted Diode) in the seven-segment display unit 1041. Therefore, a symbol that can be clearly recognized by humans' eyes, such as the Arabic numerals or alphabetical characters, is displayed on the seven-segment display unit 1041. Accordingly, a power-on error message reference table is configured, which can be referred by the users of the computer system 11.

Since a combination of the LPC interface 103 and the LPC decoder 1022 is applied, the present embodiment significantly saves the occupied space when comparing with the LPC interface of 9 signals and the MINI PCI interface of 124 signals. In the present embodiment, multiple LPC connectors, such as the TCPA (trusted computing platform alliance) module connector, the firmware IC slot, the mini card slot, or a 9-pin socket reserved on the motherboard where the LPC bus is connected, can be used to connect to the computer system 11. Moreover, the debugging device using the LPC interface has less number of circuits, which reduces the cost.

A backup copy of BIOS is stored in the firmware hub 101. When the original BIOS in the SPI FLASH 111 of the computer system is damaged, the computer system 11 fails to startup. Meanwhile, the firmware hub 101 sends a control signal to the controller chipset 112 through the LPC interface 103, and the control signal controls the computer system to start up by using the backup BIOS stored in the firmware hub 101 rather than using the original damaged BIOS stored in the SPI FLASH 111. The way of applying the embodiment of modifying the BIOS in the computer system 11 into the current industry specification is described in great detail hereinafter. The controller chipset 112, such as the Intel south bridge chipset ICH-7M, enforces the computer system 11 to control the firmware hub 101 via the strap ping GNT5#/GNT#T4 of the south bridge chipset ICH-7M to read the backup BIOS to startup the computer system 11. Once the computer system 11 is successfully started up by the firmware hub 101, the original damaged BIOS in the SPI FLASH 111 is recovered by the read-write program in the SPI FLASH 111. Then, next time the computer system 11 is booted up by using the SPI FLASH 111, thus the original damaged BIOS is recovered.

In the present embodiment, the firmware hub 101 uses the backup BIOS to recover the original damaged BIOS. Accordingly, the present embodiment does not need to purchase any SPI FLASH programming unit or adapter for repairing the BIOS. The present embodiment does not need to remove the SPI FLASH from the motherboard, and neither to add additional connector to repair the BIOS, thus the repairing time is saved and the possibility of damaging other components in repairing the BIOS is reduced. In addition, the debugging device 10 may be installed on an object complying with the mini card industry specification. The mini card is characterized with a compact size and supports the PCIe (peripheral component interconnection express) and USB (universal serial bus). The debugging and recovering of the BIOS is performed on the mini card through the LPC interface, which further increases the convenience of the users.

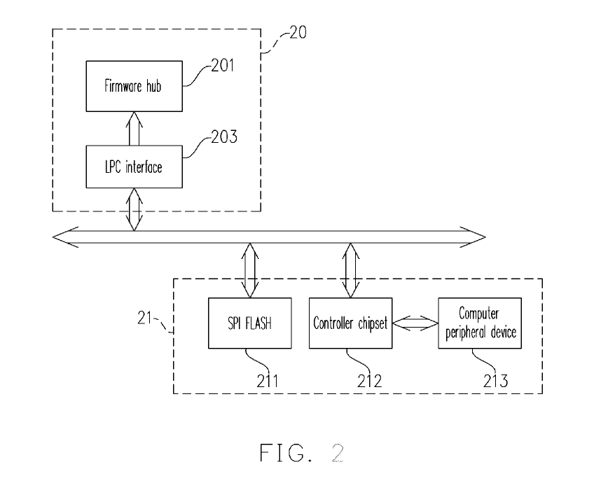

FIG. 2 is a circuit diagram of a debugging device using an LPC interface and capable of recovering the BIOS functions according to another embodiment of the present invention. The debugging device 20 comprises a firmware hub 201 and an LPC interface 203. The firmware hub 201 stores a backup copy of BIOS. The LPC interface 203 is electrically coupled to a computer system 21 through an LPC bus. The computer system 21 comprises an SPI FLASH 211, a controller chipset 212, and a computer peripheral device 213. The SPI FLASH 211 contains the original BIOS that is required for starting up the computer system 11, and the components inside the computer peripheral device 213 are respectively tested by the controller chipset 212. When the original BIOS stored in the SPI FLASH 211 is damaged, the controller chipset 212 reads the backup BIOS to startup the computer system 21 from the firmware hub 201 through the LPC interface 203. After the computer system is successfully booted up, the original damaged BIOS of the SPI FLASH 211 is recovered by the backup BIOS. The debugging device 20 may be installed on an object complying with the mini card industry specification, and the debugging device 20 can perform the debugging and recovering BIOS functions through the LPC interface.

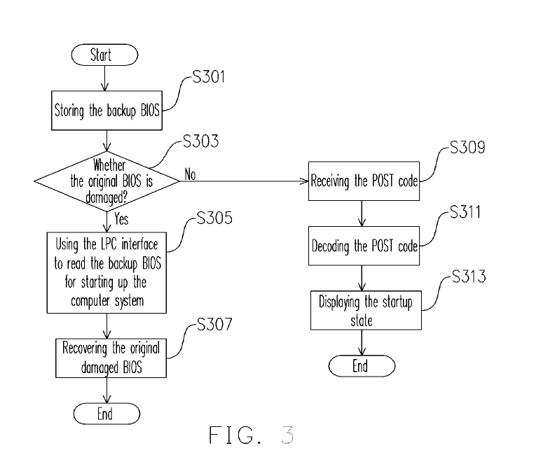

FIG. 3 is a flow chart illustrating a debugging method for recovering the BIOS functions by using an LPC interface according to an embodiment of the present invention. First, in step S301, a BIOS is backed up. Then, step S303 determines whether the original BIOS of the computer system is damaged or not. If the original BIOS is damaged, the backup BIOS is read from the firmware hub through the LPC interface to start up the computer system. Then, in step S307, the damaged BIOS is recovered by using the burning program that corresponds to the SPI FLASH.

Then, in step S303, if it is determined that the original BIOS is not damaged, the process goes to step S309 to receive the POST code, and the POST code is decoded in step S311. Finally, in step S313, the startup state of the computer system is displayed.

In summary, the debugging device and debugging method using an LPC interface and capable of recovering the BIOS functions provided by the present invention apply a structure of using the firmware hub to store the backup BIOS and using the LPC interface to receive the POST code. Accordingly, the connection area of the debugging card transmission interface is significantly reduced and the compatibility is increased. Moreover, the original damaged BIOS is recovered by the backup BIOS, which significantly reduces the repairing cost and time.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A debugging device using an LPC (low pin count) interface and capable of recovering the BIOS (basic input/output system) functions, comprising:
a firmware hub for storing a backup copy of BIOS, wherein when an original BIOS of a computer system is damaged and failed to startup, the firmware hub provides the backup BIOS for the computer system to start up, and the firmware hub uses the backup BIOS to recover the original damaged BIOS of the computer system;
a decoder electrically connected to the LPC interface for receiving a POST (power on self test) code of the computer system and decoding the POST code into a decoded signal;
an LPC interface electrically connected to the firmware hub, the decoder, and the computer system to transmit a control signal of the firmware hub to the computer system, and to transmit the POST code of the computer system to the decoder; and
a display unit electrically connected to the decoder for receiving the decoded signal from the decoder and displaying a startup state.

2. The debugging device using the LPC interface and capable of recovering the BIOS functions of claim 1, wherein the debugging device is installed on a mini card.

3. The debugging device using the LPC interface and capable of recovering the BIOS functions of claim 1, wherein the decoder comprises a seven-segment display decoder.

4. The debugging device using the LPC interface and capable of recovering the BIOS functions of claim 1, wherein the display unit is a seven-segment display unit.

5. A debugging device using an LPC (low pin count) interface and capable of recovering the BIOS (basic input/output system) functions, comprising:
a firmware hub for storing a backup copy of BIOS, wherein when an original BIOS of a computer system is damaged and failed to startup, the firmware hub provides the backup BIOS for the computer system to start up, and the firmware hub uses the backup BIOS to recover the original damaged BIOS of the computer system; and
an LPC interface electrically connected to the firmware hub and the computer system to transmit a control signal of the firmware hub to the computer system.

6. The debugging device using the LPC interface and capable of recovering the BIOS functions of claim 5, wherein the debugging device is installed on a mini card.

7. The debugging device using the LPC interface and capable of recovering the BIOS functions of claim 5, wherein the LPC interface receives a POST (power on self test) code of the computer system.

8. The debugging device using the LPC interface and capable of recovering the BIOS functions of claim 5, further comprising a decoder, wherein the decoder is electrically connected to the LPC interface for receiving the POST code of the computer system and decoding the POST code to a decoded signal.

9. The debugging device using the LPC interface and capable of recovering the BIOS functions of claim 8, wherein the decoder comprises a seven-segment display decoder.

10. The debugging device using the LPC interface and capable of recovering the BIOS functions of claim 5, further comprising a display unit, wherein the display unit is electrically connected to the decoder for receiving the decoded signal from the decoder and displaying a startup state.

11. The debugging device using the LPC interface and capable of recovering the BIOS functions of claim 10, wherein the display unit is a seven-segment display unit.

12. A debugging method for recovering the BIOS (basic input/output system) functions by using an LPC (low pin count) interface, comprising:
storing a backup copy of BIOS;
when an original BIOS of the computer system is damaged and failed to startup, providing the backup BIOS to the computer system through an LPC interface to start up the computer system; and
using the backup BIOS to recover the original damaged BIOS.

13. The debugging method for recovering the BIOS functions by using the LPC interface of claim 12, further comprising receiving a POST (power on self test) code, and decoding the POST code to display a startup state of the computer system.

14. The debugging method for recovering the BIOS functions by using the LPC interface of claim 12, further comprising displaying the startup state and performing the recovering BIOS functions on a mini card.
